(19) United States
(12) Patent Application Publication
(10) Pub. No.: US 2013/0132759 A1
(43) Pub. Date: May 23, 2013

(54) COMPUTER COMPONENT POWER-CONSUMPTION DATABASE

(71) Applicants: Frederick L. Lathrop, Spring, TX (US); Tu G. Nguyen, Houston, TX (US)

(72) Inventors: Frederick L. Lathrop, Spring, TX (US); Tu G. Nguyen, Houston, TX (US)

(21) Appl. No.: 13/812,596

(22) PCT Filed: Jul. 29, 2010
(86) PCT No.: PCT/US10/43695

§ 371 Date: Jan. 28, 2013

(51) Int. Cl. G06F 11/30

(52) U.S. Cl. CPC G06F 11/3062
USPC 713/340; 713/300

(57) ABSTRACT

A computer has components having respective baseline component settings and non-baseline component settings. The computer includes storage media encoded with a program for comparing power consumption when non-baseline settings are in effect with power consumption when a baseline computer setting is in effect to determine power-consumption values to be stored in a database.

### BACKGROUND

Power management is being implemented in computers of all sizes, e.g., to extend battery life in mobile devices and to curtail energy costs in large installations. Users, administrators, and automated power-management programs can turn off unused hardware and software components and set other components to lower performance levels to save power. Also, usage profiles can be established and selected so that users are riot required to consider the settings for each component separately. For example, a “mobile” profile can include diming a display to save battery capacity and turning on a cellular modem to maintain connectivity while a “docked” profile can use a brighter display but turn off the cellular modem (in favor of an Ethernet connection provided by the dock). Other preset and user-defined profiles can be provided.

### BRIEF DESCRIPTION OF THE DRAWINGS

Advantages of one or more disclosed embodiments may become apparent upon reading the following detailed description and upon reference to the drawings in which:

FIG. 1 is a block diagram of a computer in accordance with an embodiment;

FIG. 2 is a flow chart of a method in accordance with an embodiment;

FIG. 3 is a block diagram of a computer in accordance with an embodiment; and

FIG. 4 is a flow chart of a method in accordance with an embodiment.

### DETAILED DESCRIPTION

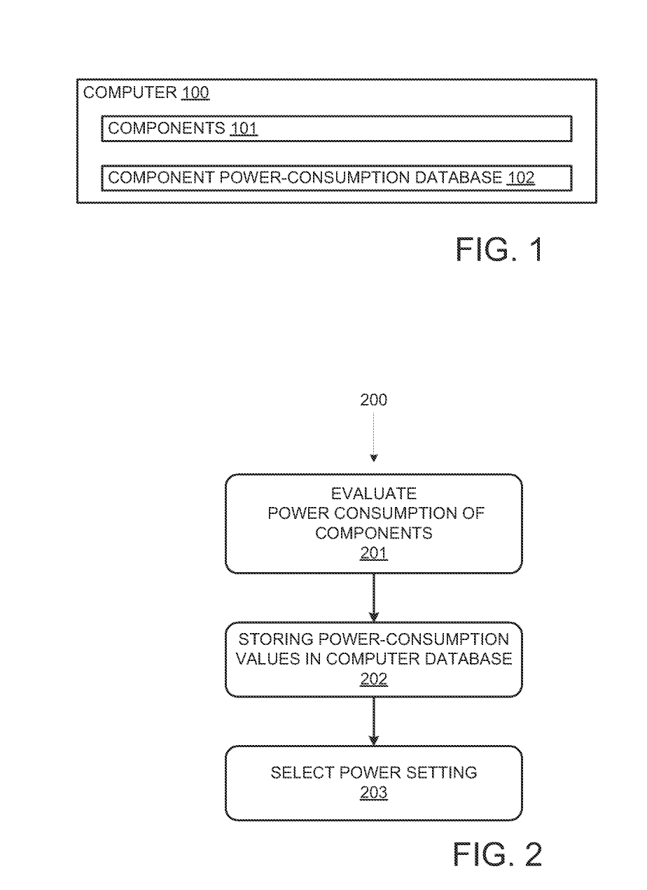

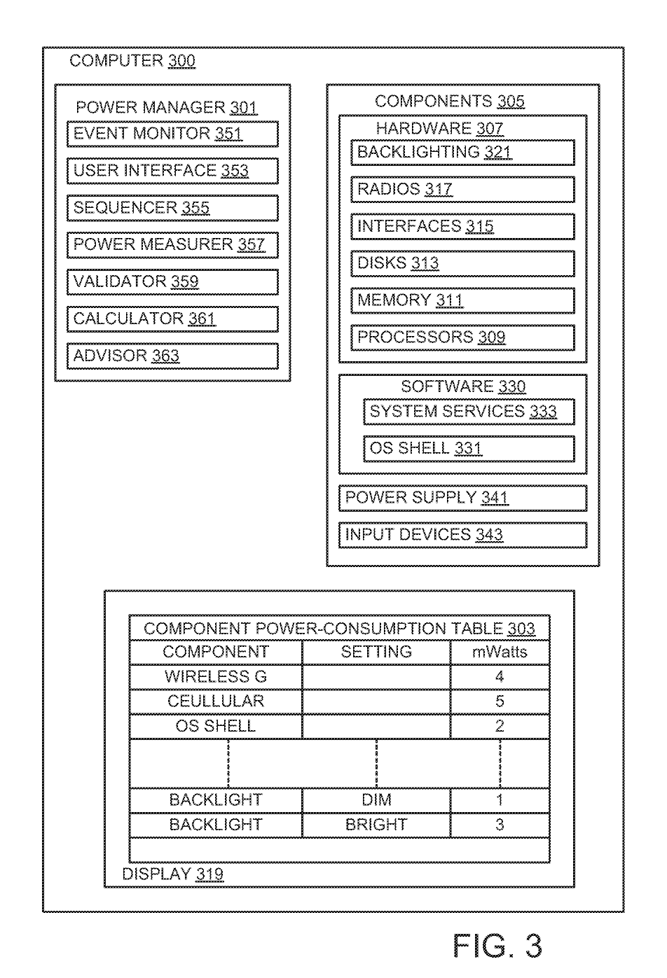

A computer 100, as shown in FIG. 1, can include components 101 and a quantitative component power-consumption database 102 for at least some of the components, in at least some embodiments. Computer system 100 can be configured to implement a method 200 shown in the flow-char in FIG. 2. Method 200 may include functionality for evaluating the power consumption of computer components a block 201 to generate the quantitative component power-consumption data, which is stored on the computer in database 102 at block 202. Block 203 may include functionality for selecting a power setting at least in part as a function of the quantitative component power-consumption data in database 102.

In some embodiments, an external power manager can generate the power-consumption data, e.g., at the factory that manufacturers the computer. In other embodiments, an internal power manager can be configured to generate the power-consumption data, e.g., in the field, so that the data can be current and take the current configuration. and current conditions into account. For example, the power consumed by a wireless radio can be affected by the distance of the computer from a wireless access point; the effect of the distance to the wireless access point can be more readily accounted for when the data is determined in the field, e.g., by an internal power manager.

Accordingly, as shown in FIG. 3 in at least some embodiments, a computer 300 can include an internal power manager 301 for generating and updating a component power consumption database table 303 quantitatively indicating the power-consumption of computer components 305. Components 305 may include hardware components 307 including processors 309, memory 311, optical and magnetic disks 313, hardware interfaces e.g., Universal Serial Bus (USB), Secure Digital (SD) card, video port) 315, radios (e.g., cellular, Blue tooth, Global Positioning System (GPS), Frequency Modulation (FM)) 317, a display 319, and backlighting (e.g., for the display and keyboard) 321.

Computer components 305 can include what are referred to herein as “software components” 330. However, as those skilled in the art would understand, software per se consumes no power; rather the hardware included in executing software consumes power. Thus, herein, reference to the power consumption of a software component refers to a difference in power consumption by hardware components when the software component is active rather than inactive (not being executed or being maintained in some baseline state). One example of a software component can include an operating-system shell 311, e.g., the Aero interface that can be activated and inactivated in Windows 7, available from Microsoft Corporation. In addition, system services 333 such as background print spooling, screen savers, and auto-updating programs can be activated and deactivated so as to have an effect on power consumption.

As shown in FIG. 3, in one embodiment, component power-consumption table 303 may include columns for “component”, “setting” and power consumption in milliwatts (“mWatts”). Each row corresponds to a non-baseline power setting of a component. For components with only one non-baseline setting (e.g., a wireless C radio may have only an “on” setting other than a baseline “off” setting), it may be represented by only one row and the non-baseline setting need not be explicitly specified.

Components with more than one non-baseline setting may be represented by more than one row. For example, “backlight” has “bright” and “dim” non-baseline settings as opposed to a “minimum” or “off” baseline setting. Depending on the component, the baseline setting may be an “off”, “disabled”, “idle”, or other minimum setting. Some components, e.g., power manager 301, a power supply 341 and integrated input devices 343 (e.g., a laptop keyboard) are not represented in table 303 because the available power profiles do not provide for different modes of operation for these components.

In FIG. 3, table 303 is shown in human readable form as presented on display 319. However, table 303 can be implemented in computer-readable form as encoded in non-transitory tangible computer-readable storage media such as memory 311 and disks 313, and may be displayed in human readable form in response to appropriate commands. In some embodiments, the power-consumption database may be stored in multiple tables or in other forms rather than in a single table.

Power manager 301 can include an event monitor 351, a user interface 353, a sequencer 355, a power measurement circuit 357, a validator 359, a calculator 361, and a power advisor 363. Event monitor 351 can be adapted to detect events, such as a configuration change, that might cause current power data in table 303 (or data being collected) to be invalid. For example, if a new component is added to the computer, or if a new service pack is applied to the operating system, power consumption can be impacted. Thus, event monitor 351 can be used to suggest or determine when to update table 303. User interface 353 can be adapted to allow a user to determine whether or not to proceed with updating table 303 and to allow a user to select a power profile setting based on table 303.

When it is determined that table 303 is to be updated, sequencer 355 may control the settings of the components to be assessed, and power measurement circuit 357 can be used to determine the power consumptions of components at times determined in part by sequencer 357. By keeping specific control over the component settings, the resulting power measurement can be used to isolate and approximate power consumption for individual devices and/or software services running on the computer. Power measurer 357 can be, for example, an HP Power Monitoring Circuit (PMC) as used in business notebook computers available from Hewlett-Packard Company.

During a testing sequence, event monitor 351 can monitor for events that might: invalidate a power measurement. Thus, event monitor 351 can be used to ensure power measurements taken while during transient conditions are not used in computing power values. Also, event monitor 351 is adapted to invalidate power data if a configuration change (e.g., a switch from battery power to AC power) occurred as the data was collected. Validator 359 can be configured to make validation determinations based at least in part on event detections (or lack thereof) by event monitor 351. if the power measurement data is valid, calculator 361 can be used to calculate a value or values to be inserted in the mWatt power column of the appropriate row.

Advisor 363 can use the power consumption data in table 303 for predicting battery life and/or power cost impacts. In addition, advisor can be used to recommend power configurations and to otherwise assist users in making and understanding device, software, and system configuration decisions. In the context of a laptop or other battery-operated computer, advisor 363 can provide recommendations for extending battery life while minimally impairing performance. In the context of an enterprise computer system, advisor 363 can provide recommendations for achieving performance objectives while minimizing energy costs.

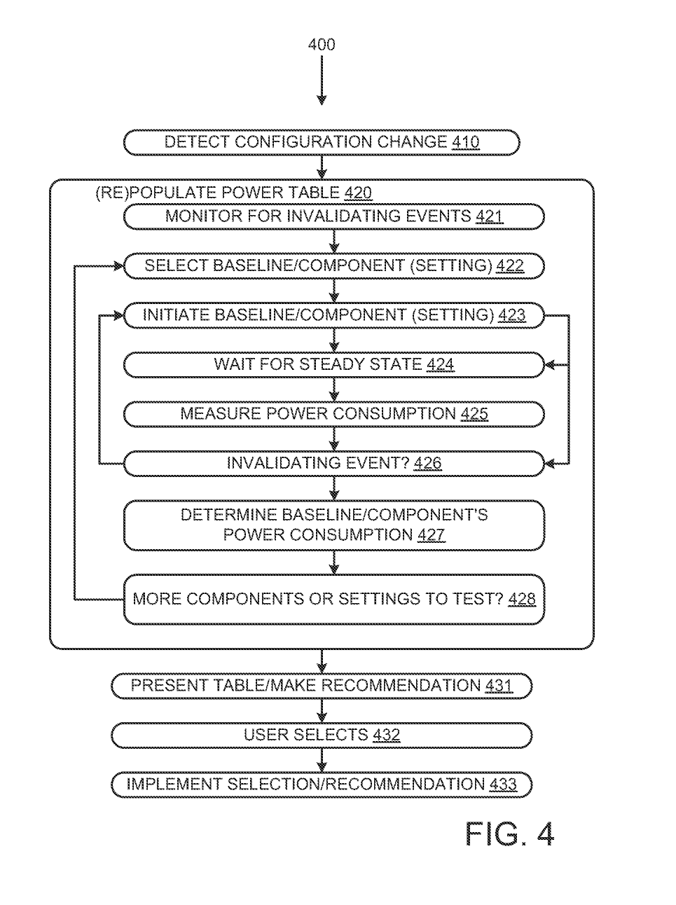

Power manager 301 is configured to implement method 400 shown in flow-chart in FIG. 4, in accordance with one embodiment. At block 410 an event is detected that can result in an update or a recommendation for an update to table 303. For example, event monitor 351 may detect a configuration change that could impair the validity of the power data in table 303. For example, a memory upgrade or installation of new background services may change the amount of power required in certain power configurations. Monitor 351 can detect these; in response, power manager 301 can recommend via user interface 353 that table 303 be updated. Alternatively, block 410 can include receiving a user initiated command to update table 303 in response to a detection of an event by monitor 351.

In response to a user accepting a recommendation to update or a user-initiated command to update, block 420 provides for updating table 303. In some cases, this can include adding component-setting rows to table 303. For example, when a new device is added via a peripheral component interconnect (PCI) or PCIe slot of a computer, one or more rows can be added to table 303 to represent that device's non-baseline settings. In other cases, no rows are added. For example, the opening of a new user account or the detection of a newly available wireless access point may trigger an update that does not include adding rows to table 303.

In one embodiment, block 420 may include several subblocks, herein just referred to as “blocks”. At block 421, event monitor 351 can be configured to monitor for invalidating events. Block 421 can be ongoing throughout block 420.

At block 422, a component can be selected for measurement. If there are multiple non-baseline settings for the component, they can be selected on different iterations of block 422. In an iteration of block 422, no component is selected so that a baseline computer power-consumption measurement can be obtained. Block 423 may include initiating the selected non-baseline component setting or the baseline computer setting. This can include turning components off, turning components on, and/or adjusting component settings.

Block 424 can include waiting for steady state conditions to be achieved before measurements are considered valid. This can include monitoring Central Processing Unit (CPU) utilization, which may typically rise during initialization and fall to a steady-state level; power measurement can begin once CPU utilization has reached a steady relatively low level. Alternatively, block 424 can include sequencer 355 waiting a preset period of time known to be sufficient for steady state conditions to be achieved. Alternatively, event monitor 351 can detect: an event (e.g., a “ready” acknowledgement” indicating steady state has been achieved. Alternatively, power measurement data can be collected and analyzed to determine when steady state was achieved so that transient data can then be discarded.

Power consumption can be measured at block 425. This can include sensing current at the computer input or at the output of an internal power supply. In one example, the sensing is continuous and block 425 can identify durations beginning after transients have subsided.

At block 426, validator 359 can check data from event monitor 331 to determine if any invalidating conditions occurred during a time that presumed valid data was collected. If a user switched from alternating current (AC) power to battery power or launched an application during a presumed valid duration, the data can then be invalidated. In that case, the measurement can be repeated by returning to block 423. AC power may refer to external AC power accessed via a wall outlet.

If there were no invalidating conditions (for the current iteration), calculator 361 can calculate a power-consumption value for the baseline, component, or component setting at block 427. In the case of a baseline measurement, an average power of the valid time period can be taken. In the case of a component or a component setting, the difference between the average power of the valid time period and a previously obtained baseline power value can be obtained. For iterations in which a component or component setting is being evaluated, the result can be stored in the appropriate cell of table 303.

Due to component dependencies, some calculations may combine a difference between a current component power-consumption measurement and a previously obtained power-consumption measurement for another component with the power value associated with the other component. For example, determining a power associated with a disk intensive application may require that the disk be operating when determining a power value for the application. In such a case, the power consumed when the application is running can be compared with the power consumed when the application is not running but the disk is running, rather than a baseline condition when the disk is not running.

At block 428, sequencer 355 can determine whether there are one or more components or component settings for which power consumption measurements are to be made. If so, block 420 can return to block 422 for the next iteration. Otherwise, power manager 301 can present a recommended power profile setting to the user at block 431. At block 432, the user selects a power profile setting, either accepting the recommendation or selecting an alternative. At block 433, power manager 301 can implement the selected power profile.

While it allows a user to individually activate, inactivate, and adjust the settings for individual components, power manager 353 can present a user with power-setting profiles optimized for various use scenarios. For an example applicable to a laptop computer, the settings for several components when the laptop is being used for in office use while attached to AC power can be different from use as an alarm clock and email client when using battery power. Another profile may include turning off a cellular radio when a Wi-Fi access point is in range for mobile use. By presenting power profiles in the form of common use scenarios, power manager 301 can relieve the user of having to make power-consumption decisions on a component-by-component basis.

In an alternative embodiment, the power measurements can be made by an external device inserted between AC power and the computer. The sequencer can be a software program running on the computer. Communication between the power measurement device and the sequencer can be through an input/output port, e.g., a USB port.

In another embodiment, the component power consumption table can completed at the time of manufacture. In that embodiment, a larger table may take into account all possible configurations in which the computer may he sold and some of the possible upgrade configurations (e.g., resulting from a memory upgrade).

Since power management typically includes tradeoffs, e.g., between power consumption and performance, accurate information regarding the impact a change in power configuration may have on parameters of interest (e.g., power consumption, battery life, energy cost) can lead to more effective decision making.

A “component setting” is a setting for a component, e.g., a “baseline component setting” or a “non-baseline component setting”. Typical baseline component settings include “power off”, “idle”, “unlaunched”, and “unloaded”. Typical non-baseline power states include “active”, “launched”, “high-performance settings,” and “low-performance settings”. For example, a processor can have a high-performance high-power-consumption setting, a (reduced) mid-performance mid-power-consumption setting, and a low-performance low-power setting. In some embodiments, e.g., in which a processor must be active for power consumption to be evaluated, the low-performance selling can be the baseline setting for the processor. In other embodiments, e.g., where more than one processor is available, a power off or idle state can be the baseline processor state. A computer can also have a “baseline computer setting” in which as many components as possible are in their baseline component settings.

A computer manufacturer can include a power table associating power-consumption values with non-baseline component settings. Such a table can include configurations of the computer as shipped and also configurations that: can occur in various upgrade scenarios. Such tables can be used to answer questions such as “Flow much longer will the battery last if I turn off the wireless radio?”, “How much money can I save today if I run two processors instead of four”. An administrator, user, or automated control system can then use this information in managing the computer.

Herein, a “computer” can be a system including: storage media encodable with instructions and at least one processor for executing the instructions. The computer can be implemented as a laptop computer, a portable computer, a netbook computer, a tablet computer, a cellular device, a handheld gaming system, or an ultraportable computer. Herein, “storage media” refers to non-transitory tangible storage media. Herein, “processor” refers to a hardware device including at least some conductive material such as metal for conducting electricity or optical fiber for conducting light.

Herein, a “system” can include a set of interacting elements, wherein the elements can be, by way of example and not of limitation mechanical components, electrical elements, atoms, instructions encoded in storage media, and process segments. In this specification, related art is discussed for expository purposes. Related art labeled “prior art”, if any, is admitted prior art. Related art not labeled “prior art” is not admitted prior art. The illustrated and other described embodiments, as well as modifications thereto and variations thereupon are within the scope of the following claims.

What is claimed is:

1. A computer comprising:
a plurality of components having respective baseline component settings and respective non-baseline settings; and
storage media encoded with a power-consumption database, said power-consumption database associating quantitative power-consumption values with said non-baseline component settings.

2. The computer as recited in claim 1 further comprising a power manager, said power-consumption database comprising a table relating non-baseline component settings to respective quantitative power-consumption values, said power manager for updating said table by controlling and sequencing said component settings and measuring power-consumption while respective component settings are in effect.

3. The computer as recited in claim 2 wherein said power manager includes a sequencer for sequencing component settings for said components so contributions of those components in their non-baseline component settings to power consumption can be isolated.

4. The computer as recited in claim 3 wherein said power manager excludes power measurements taken during a transient interval after a setting adjustment from consideration in evaluating power consumption associated with a component setting.

5. The computer as recited in claim 3 wherein said power manager includes an event detector for detecting invalidating events that might invalidate power consumption data for a setting selected from a set comprising a baseline computer setting and a non-baseline component setting, said power manager discarding power-consumption data for a setting if an invalidating event is detected while power consumption data is being collected for that setting.

6. The computer as recited in claim 2 wherein said table associates a quantitative power-consumption value with a reduced power setting for a processor.

7. The computer as recited in claim 2 wherein said table associates a software component setting with a power consumption value corresponding to an increase of power consumed by said computer when said software component is in an active non-baseline setting relative to power consumed by said computer when said software is in an inactive or other baseline component setting,

8. The computer as recited in claim 3 wherein said sequencer provides for putting said computer in a baseline computer setting so that said power manager can obtain a baseline computer power-consumption value for said computer.

9. A method comprising;
measuring power consumption associated with non-baseline settings of components of a computer to provide quantitative power-consumption values;
storing said power-consumption values in association with respective non-baseline component settings in a database on said computer; and
selecting a power setting for said computer at least in part as a function of said power-consumption values in said database.

10. The method as recited in claim 9 wherein said database comprises a table that associates said power-consumption values with component settings.

11. The method as recited in claim 10 wherein said components include at least one processor.

12. The method as recited in claim 11 wherein said components include at least one program of computer-executable instructions, said table associating with said program a power-consumption value corresponding to an increase in power consumed by said computer when said program is in a non-baseline component setting over power consumed by said computer when said program is in a baseline component setting.

13. The method as recited in claim 11 further comprising, prior to said measuring, detecting an event on said computer that invalidates some values in said table and performing said measuring in response to said event.

14. The method as recited in claim 11 further comprising detecting an event on said computer that invalidates data collecting during said measuring and, in response, discarding invalidated data and collecting new power-consumption data to replace it.

15. The method as recited in claim 11 wherein said measuring includes measuring power consumption by said computer when said computer is in a baseline computer setting prior to collecting power consumption data for individual ones of said components.

16. A computer product comprising computer-readable storage media encoded with code configured for, when executed by a processor,
evaluating power consumption for non-baseline component settings of computer components of a computer to determine respective power-consumption values; and
storing said power-consumption values in said media so as to associate said power-consumption values with their respective non-baseline component settings.

17. The computer product as recited in claim 16 wherein said evaluating includes:
measuring baseline power consumption by said computer when the corresponding component setting is in effect to yield a respective component power consumption measurement; and
calculating said power-consumption values by comparing said component power consumption measurement with a baseline computer power consumption measurement taken when a baseline component setting for said component is in effect.

18. The computer product as recited in claim 17 wherein said evaluating includes, for each of plural components, collecting power consumption data while that component is in a non-baseline setting and others of said plural components are in respective baseline settings.

19. The computer product as recited in claim 17 wherein said code is further configured for detecting events that invalidate power consumption values in said table or power-consumption data collected during said evaluating.

20. The computer product as recited in claim 17 wherein said code is further configured for making a recommendation to a user as a function of said power-consumption values in said table.
